(19) United States
(12) Patent Application Publication
(10) Pub. No.: US 2022/0133456 A1
(43) Pub. Date: May 5, 2022

(54) Dental Hygiene Device

(71) Applicant: Ronald Hausinger, North Bend, WA (US)

(72) Inventor: Ronald Hausinger, North Bend, WA (US)

(21) Appl. No.: 17/088,278

(22) Filed: Nov. 3, 2020

(51) Int. Cl. A61C 17/22; A61C 17/34

(52) U.S. Cl. CPC A61C 17/222; A61C 17/3409

(57) ABSTRACT

A dental hygiene device for brushing proximal surfaces of adjoining teeth and pockets resulting from crooked teeth includes a shaft, which has a first end and a second end. The first end is attachable to an electric toothbrush so that the shaft is operationally engaged thereto. The shaft is oscillated by the electric toothbrush. A plurality of bristles is engaged to and extends from the shaft proximate to the second end. The bristles oscillate coincidentally with the shaft. The plurality of bristles is tapered distal from the shaft so that the plurality of bristles is pointed. The plurality of bristles is used to brush proximal surfaces of adjoining teeth and pockets resulting from crooked teeth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hygiene devices and more particularly pertains to a new hygiene device for brushing proximal surfaces of adjoining teeth and pockets resulting from crooked teeth.

### (2) Description of Related Art Including Information Disclosed Under 37 CFR 1.97 and 1.98

The prior art relates to hygiene device. Prior art hygiene devices may comprise electric interdental toothbrushes comprising a plurality of bristles, wherein the plurality of bristles is cylindrically or conically shaped. What is lacking in the prior art is an electric interdental toothbrush having a plurality of bristles extending transversely from a base and which tapers to a point distal from the base, thereby allowing for cleaning of interproximal surfaces and pockets caused by crooked teeth

### BRIEF SUMMARY OF THE INVENTION

An embodiment of the disclosure meets the needs presented above by generally comprising a shaft, which has a first end and a second end. The first end is configured to be attachable to an electric toothbrush so that the shaft is operationally engaged thereto. The shaft is configured to be oscillated by the electric toothbrush. A plurality of bristles is engaged to and extends from the shaft proximate to the second end. The bristles oscillate coincidentally with the shaft. The plurality of bristles is tapered distal from the shaft so that the plurality of bristles is pointed. The plurality of bristles is configured to brush proximal surfaces of adjoining teeth and pockets resulting from crooked teeth.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a dental hygiene device according to an embodiment of the disclosure.

FIG. 2 is a side view of an embodiment of the disclosure.

FIG. 3 is a detail view of an embodiment of the disclosure.

FIG. 4 is a bottom view of an embodiment of the disclosure.

FIG. 5 is a front view of an embodiment of the disclosure.

### DETAILED DESCRIPTION OF THE INVENTION

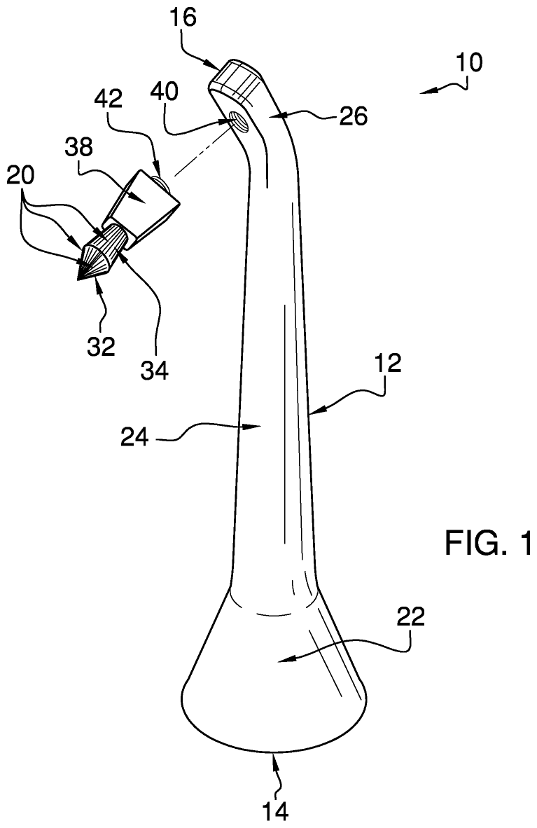

With reference now to the drawings, and in particular to FIGS. 1 through 5 thereof, a new hygiene device embodying the principles and concepts of an embodiment of the disclosure and generally designated by the reference numeral 10 will be described.

As best illustrated in FIGS. 1 through 5, the dental hygiene device 10 generally comprises a shaft 12, which has a first end 14 and a second end 16. The first end 14 is configured to be attachable to an electric toothbrush 18 so that the shaft 12 is operationally engaged thereto. The shaft 12 is configured to be oscillated by the electric toothbrush 18. A plurality of bristles 20 is engaged to and extends from the shaft 12 proximate to the second end 16. The bristles 20 oscillate coincidentally with the shaft 12. The plurality of bristles 20 is tapered distal from the shaft 12 so that the plurality of bristles 20 is pointed. The plurality of bristles 20 is configured to brush proximal surfaces of adjoining teeth and pockets resulting from crooked teeth.

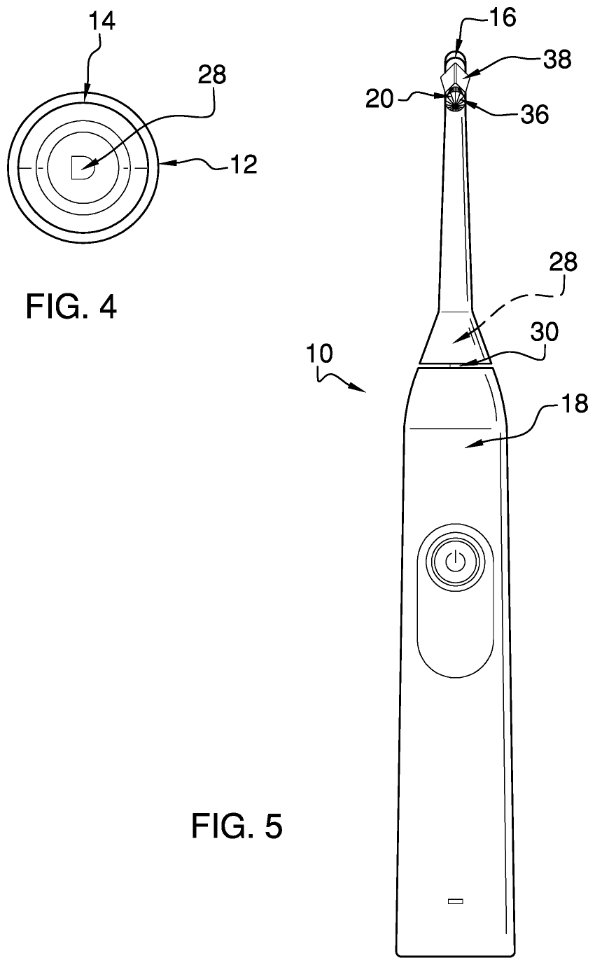

The shaft 12 comprises a proximal section 22, a medial section 24, and a distal section 26. The proximal section 22 is conical frustum shaped and has a channel 28 extending thereinto, as shown in FIG. 4. The channel 28 is complementary to a driveshaft 30 of the electric toothbrush 18 and thus is configured for insertion of the driveshaft 30 to operationally engage the shaft 12 to the electric toothbrush 18, as shown in FIG. 5.

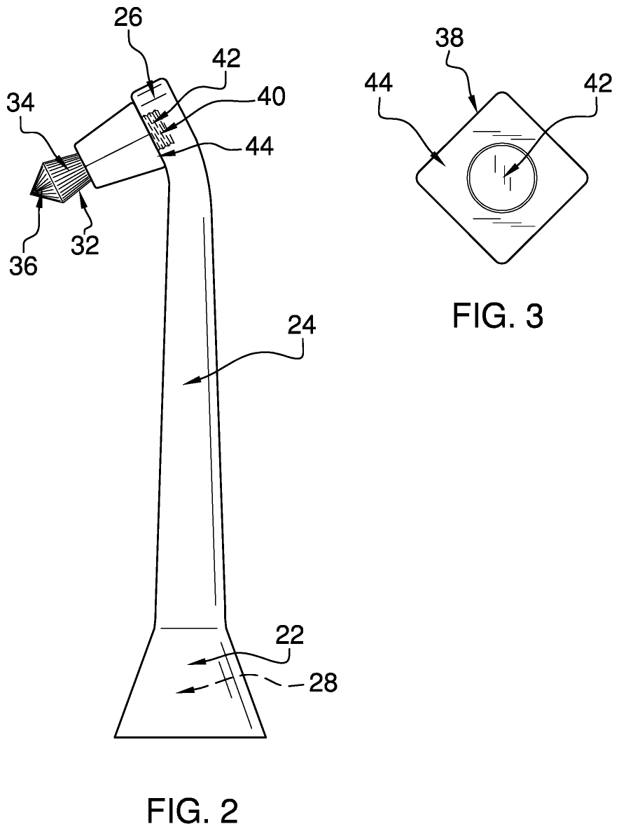

The medial section 24 is engaged to and extends linearly from the proximal section 22. The medial section 24 is tapered so that the medial section 24 is circumferentially smaller distal to the proximal section 22. The distal section 26 is engaged to the medial section 24 distal from the proximal section 22 and extends transversely therefrom, as shown in FIG. 2.

Each bristle 20 has a respective length 32 so that the plurality of bristles 20 comprises bristles 20 having a variety of lengths 32. The bristles 20 of the plurality of bristles 20 are arranged so that the plurality of bristles 20 comprises a first section 34 and a second section 36. As shown in FIG. 2, the first section 34 is positioned proximate to the shaft 12 and is conical frustum shaped so that the first section 34 is circumferentially smaller proximate to the shaft 12. The second section 36 extends from the first section 34, is positioned distal from the shaft 12, and is conically shaped. The second section 36 is circumferentially smaller and pointed distal from the first section 34. The second section 36 is configured to brush proximal surfaces of adjoining teeth and pockets resulting from crooked teeth.

A base 38 is engaged to and positioned between the shaft 12 and the bristles 20. The base 38 is reversibly engageable to the shaft 12, as shown in FIG. 1. The base 38 may be square frustum shaped, as shown in FIGS. 1 and 3, or alternatively shaped, such as, but not limited to, conical frustrum shaped, cylindrical, and the like.

The shaft 12 has an indent 40 positioned therein proximate to the second end 16, as shown in FIG. 1. The indent 40 is internally threaded. A post 42 is engaged to and extends from a bottom 44 of the base 38, as shown in FIG. 3. The post 42 is externally threaded and thus is complementary to the indent 40. The post 42 is positioned to be selectively and threadedly inserted into the indent 40 to removably engage the base 38 to the shaft 12.

In use, the post 42 is threadedly inserted into the indent 40 to engage the base 38 to the shaft 12. The driveshaft 30 is inserted into the channel 28 to operationally engage the shaft 12 to the electric toothbrush 18. The electric toothbrush 18 then is actuated to oscillate the shaft 12 and the plurality of bristles 20 to brush proximal surfaces of adjoining teeth and pockets resulting from crooked teeth.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A dental hygiene device comprising:
a shaft having a first end configured to be attachable to an electric toothbrush, such that the shaft is operationally engaged thereto, wherein the shaft is configured for being oscillated by the electric toothbrush; and
a plurality of bristles engaged to and extending from the shaft proximate to a second end thereof, such that the bristles oscillate coincidentally with the shaft, the plurality of bristles being tapered distal from the shaft such that the plurality of bristles is pointed, wherein the plurality of bristles is configured for brushing proximal surfaces of adjoining teeth and pockets resulting from crooked teeth.

2. The dental hygiene device of claim 1, wherein the shaft comprises:
a proximal section, the proximal section being conical frustum shaped, the proximal section having a channel extending thereinto, the channel being complementary to a driveshaft of the electric toothbrush, wherein the channel is configured for insertion of the driveshaft for operationally engaging the shaft to the electric toothbrush;
a medial section engaged to and extending linearly from the proximal section, the medial section being tapered such that the medial section is circumferentially smaller distal to the proximal section; and
a distal section engaged to the medial section distal from the proximal section and extending transversely therefrom.

3. The dental hygiene device of claim 1, wherein each bristle has a respective length such that the plurality of bristles comprises bristles having a variety of lengths, the bristles of the plurality of bristles being arranged such that the plurality of bristles comprises a first section, positioned proximate to the shaft, and a second section extending from the first section and being positioned distal from the shaft, the first section being conical frustum shaped such that the first section is circumferentially smaller proximate to the shaft, the second section being conically shaped such that the second section is circumferentially smaller and pointed distal from the first section, wherein the second section is configured for brushing proximal surfaces of adjoining teeth and pockets resulting from crooked teeth.

4. The dental hygiene device of claim 1, further including a base engaged to and positioned between the shaft and the bristles, the base being reversibly engageable to the shaft.

5. The dental hygiene device of claim 4, wherein the base is square frustum shaped.

6. The dental hygiene device of claim 4, further including:
the shaft having an indent positioned therein proximate to the second end, the indent being internally threaded; and
a post engaged to and extending from a bottom of the base, the post being externally threaded such that the post is complementary to the indent, such that the post is positioned for selectively threadedly inserting into the indent for removably engaging the base to the shaft.

7. A dental hygiene device and electric toothbrush combination comprising:
an electric toothbrush;
a shaft having a first end engaged to the electric toothbrush, such that the shaft is operationally engaged thereto, such that the shaft is positioned for being oscillated by the electric toothbrush; and
a plurality of bristles engaged to and extending from the shaft proximate to a second end thereof, such that the bristles oscillate coincidentally with the shaft, the plurality of bristles being tapered distal from the shaft such that the plurality of bristles is pointed, wherein the plurality of bristles is configured for brushing proximal surfaces of adjoining teeth and pockets resulting from crooked teeth.

8. The dental hygiene device and electric toothbrush combination of claim 7, wherein the shaft comprises:
a proximal section, the proximal section being conical frustum shaped, the proximal section having a channel extending thereinto, the channel being complementary to a driveshaft of the electric toothbrush, such that the channel is positioned for insertion of the driveshaft for operationally engaging the shaft to the electric toothbrush;
a medial section engaged to and extending linearly from the proximal section, the medial section being tapered such that the medial section is circumferentially smaller distal to the proximal section; and
a distal section engaged to the medial section distal from the proximal section and extending transversely therefrom.

9. The dental hygiene device and electric toothbrush combination of claim 7, wherein each bristle has a respective length such that the plurality of bristles comprises bristles having a variety of lengths, the bristles of the plurality of bristles being arranged such that the plurality of bristles comprises a first section, positioned proximate to the shaft, and a second section extending from the first section and being positioned distal from the shaft, the first section being conical frustum shaped such that the first section is circumferentially smaller proximate to the shaft, the second section being conically shaped such that the second section is circumferentially smaller and pointed distal from the first section, wherein the second section is configured for brushing proximal surfaces of adjoining teeth and pockets resulting from crooked teeth.

10. The dental hygiene device and electric toothbrush combination of claim 7, further including a base engaged to and positioned between the shaft and the bristles, the base being reversibly engageable to the shaft.

11. The dental hygiene device and electric toothbrush combination of claim 10, wherein the base is square frustum shaped.

12. The dental hygiene device and electric toothbrush combination of claim 10, further including:
the shaft having an indent positioned therein proximate to the second end, the indent being internally threaded; and
a post engaged to and extending from a bottom of the base, the post being externally threaded such that the post is complementary to the indent, such that the post is positioned for selectively threadedly inserting into the indent for removably engaging the base to the shaft.

13. A dental hygiene device comprising:
a shaft having a first end configured to be attachable to an electric toothbrush, such that the shaft is operationally engaged thereto, wherein the shaft is configured for being oscillated by the electric toothbrush, the shaft having an indent positioned therein proximate to a second end thereof, the indent being internally threaded, the shaft comprising:
a proximal section, the proximal section being conical frustum shaped, the proximal section having a channel extending thereinto, the channel being complementary to a driveshaft of the electric toothbrush, wherein the channel is configured for insertion of the driveshaft for operationally engaging the shaft to the electric toothbrush,
a medial section engaged to and extending linearly from the proximal section, the medial section being tapered such that the medial section is circumferentially smaller distal to the proximal section, and
a distal section engaged to the medial section distal from the proximal section and extending transversely therefrom;
a plurality of bristles engaged to and extending from the shaft proximate to the second end, such that the bristles oscillate coincidentally with the shaft, the plurality of bristles being tapered distal from the shaft such that the plurality of bristles is pointed, wherein the plurality of bristles is configured for brushing proximal surfaces of adjoining teeth and pockets resulting from crooked teeth, each bristle having a respective length such that the plurality of bristles comprises bristles having a variety of lengths, the bristles of the plurality of bristles being arranged such that the plurality of bristles comprises a first section, positioned proximate to the shaft, and a second section extending from the first section and being positioned distal from the shaft, the first section being conical frustum shaped such that the first section is circumferentially smaller proximate to the shaft, the second section being conically shaped such that the second section is circumferentially smaller and pointed distal from the first section, wherein the second section is configured for brushing proximal surfaces of adjoining teeth and pockets resulting from crooked teeth;
a base engaged to and positioned between the shaft and the bristles, the base being reversibly engageable to the shaft, the base being square frustum shaped; and
a post engaged to and extending from a bottom of the base, the post being externally threaded such that the post is complementary to the indent, such that the post is positioned for selectively threadedly inserting into the indent for removably engaging the base to the shaft.
